(19) United States
(12) Patent Application Publication
(10) Pub. No.: US 2022/0063115 A1
(43) Pub. Date: Mar. 3, 2022

(54) LABYRINTH FOLDABLE KNIFE

(71) Applicant: Sung SHAO CHING, Chino, CA (US)

(72) Inventor: Sung SHAO CHING, Chino, CA (US)

(21) Appl. No.: 17/022,904

(22) Filed: Sep. 16, 2020

(30) Foreign Application Priority Data
Sep. 3, 2020 (CN) 202021899934.0

(51) Int. Cl. B26B 1/04; B26B 1/10

(52) U.S. Cl. CPC B26B 1/048; B26B 1/10

(57) ABSTRACT

The present invention provides a labyrinth foldable knife, which comprises a knife handle and a knife body, wherein a labyrinth groove is provided in the knife handle, a key device being arranged in the labyrinth groove; the key device consists of a flange, a key, a spring, a sleeve and a round head screw, the key passes through the flange, the spring and the sleeve; and by means of the connection between a threaded hole and a threaded section, the key device is buckled in the labyrinth groove and can move back and forth. The present invention may be used as a foldable knife, and may also be used as a labyrinth toy for exercising a hand, thereby realizing the multi-functionalization of the foldable knife.

### FIELD

The present invention relates to the field of hardware knife manufacturing, and in particular to a labyrinth foldable knife.

### BACKGROUND

At present, due to the continuous improvement of the living standards of people, hand exercise has become an exercise manner for people to relax moods and promote the blood circulation, but a foldable knife with a traditional structure sold on the market at present is relatively single in function and is far from meeting the demands of modern people; in addition, most of existing foldable knives and labyrinth toys are separately manufactured, resulting in great waste of the space of the earth, and therefore, the inventive key point of the present invention is to design a labyrinth foldable knife which may be used as a foldable knife and may also be used for exercising a hand.

### SUMMARY

The technical problem to be solved by the present invention is to overcome the defects of the prior art and provide a labyrinth foldable knife which is simple in structure, ingenious in conception, novel in style and multiple in purpose.

The present invention is implemented by the following technical solution:

according to one technical solution adopted by the present invention, the present invention provides a labyrinth foldable knife, which comprises a knife handle and a knife body movably connected to the knife handle, wherein a labyrinth groove is provided in the knife handle, a key device being arranged in the labyrinth groove; the key device consists of a flange, a key, a spring, a sleeve and a round head screw, wherein the flange is provided with a hole site, which is movably buckled in the labyrinth groove and can move around, the key is provided with a limiting edge, a top of the key is formed into a semicircular body and a bottom thereof is provided with a threaded hole in a recessed manner, an upper end of the round head screw is provided with a threaded section correspondingly connected to the threaded hole, a lower end thereof is formed into a semicircular body, the spring is arranged in the sleeve and can stretch up and down, and the key passes through the flange, the spring and the sleeve; and by means of the connection between the threaded hole and the threaded section, the key device is buckled in the labyrinth groove and can move back and forth, the semicircular body of the round head screw makes contact with a placing hole site and a push rod arranged at the knife handle during moving of the key device, when the key device moves to the position of the push rod in the labyrinth groove, the key is pressed to support and jack the push rod to unfold the knife body, and when the key device moves to the position of the placing hole site, the round head screw is supported and jacked by the spring to enable the semicircular body to be buckled in the placing hole site to lock the key device.

Further, the labyrinth groove consists of a rapid guide groove and a slow guide groove, wherein the groove width of the labyrinth groove is set to 1 mm to 1 cm, and the groove depth thereof is set to 1 mm to 2 cm; and the key device can rapidly unfold the knife body through the movement of the rapid guide groove, and can slowly unfold the knife body through the movement of the slow guide groove.

Compared with the prior art, the present invention has the following advantages:

due to the fact that the present invention adopts the above-mentioned structure, the present invention may be used as a foldable knife, and may also be used as a labyrinth toy for exercising a hand, thereby realizing the multi-functionalization of the foldable knife, and effectively improving the value of the foldable knife, and meanwhile, achieving the effects of exercising the hand to promote the blood circulation and the multiple purposes and the tool use integration. The labyrinth foldable knife is simple in structure, ingenious in conception, convenient and practical and has very strong practicality and promotion value.

In addition to the objects, features and advantages described above, the present invention further has other objects, features and advantages. The present invention will be further described in detail below with reference to the drawings.

### BRIEF DESCRIPTION OF THE DRAWINGS

The accompanying drawings, which constitute a part of the present application, are used for providing further understanding of the present invention, and the schematic embodiments of the present invention and the descriptions thereof are used for explaining the present invention and do not constitute improper limit on the present invention. In the accompanying drawings:

FIG. 1 is a schematic structural diagram of a labyrinth foldable knife of a preferred embodiment of the present invention;

FIG. 2 is a schematic structural diagram of the labyrinth foldable knife, with a key device buckled in a placing hole site to lock the key device, of the preferred embodiment of the present invention;

FIG. 3 is a schematic structural diagram of the labyrinth foldable knife, with a knife body folded in a knife handle, of the preferred embodiment of the present invention;

FIG. 4 is a schematic structural diagram of the key device of the labyrinth foldable knife of the preferred embodiment of the present invention;

FIG. 5 is a schematic structural exploded diagram of the key device in FIG. 4 of the labyrinth foldable knife of the preferred embodiment of the present invention.

FIG. 6 is a schematic diagram of another technical solution of the labyrinth foldable knife of the preferred embodiment of the present invention.

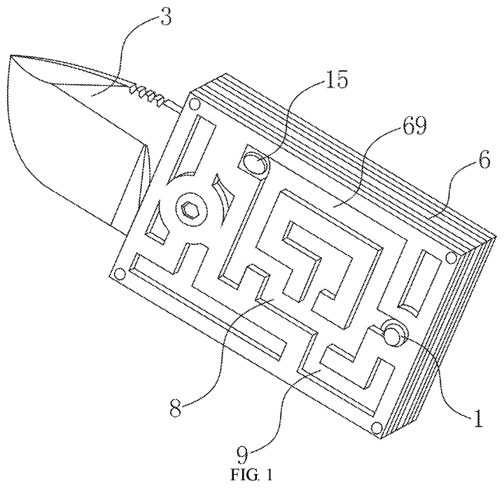

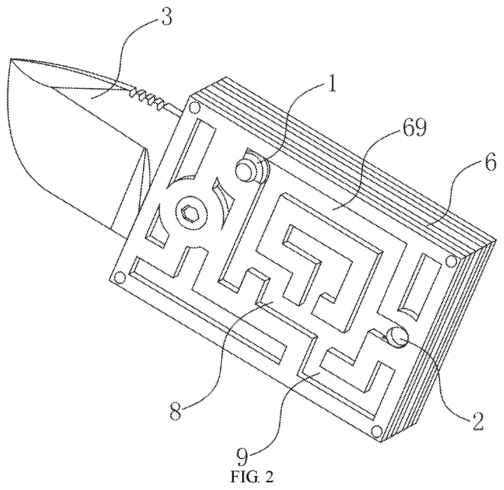

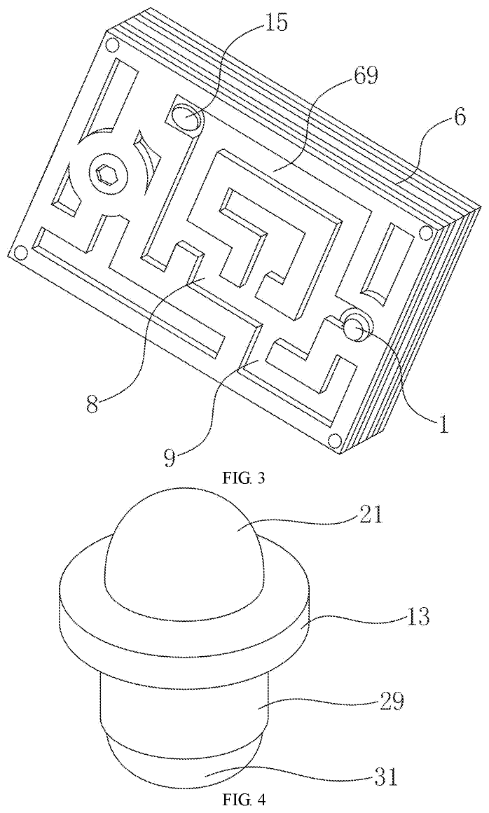

### DETAILED DESCRIPTION OF THE EMBODIMENTS

It should be noted that in the case of no conflict, the embodiments of the present application and the features in implementation may be combined with one another. The present invention will be described in detail below with reference to the accompanying drawings in conjunction with the embodiments.

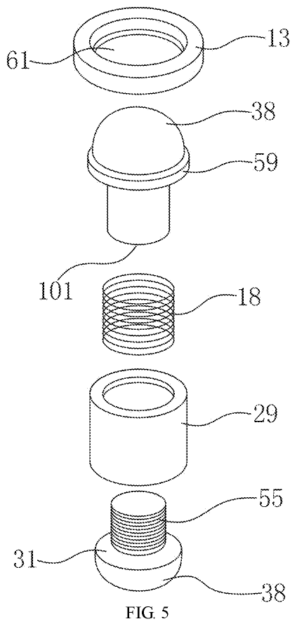

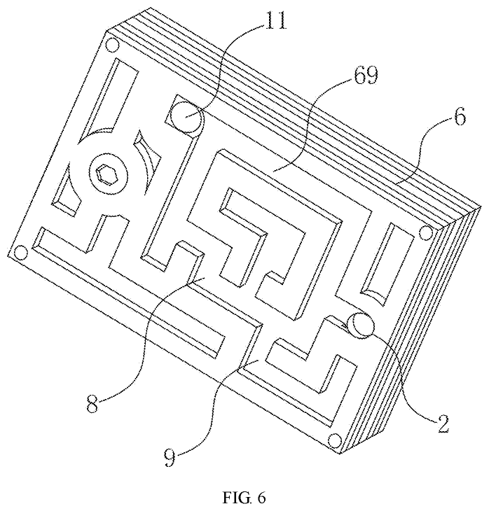

In conjunction with the contents shown in the accompanying drawing 1, the accompanying drawing 2, the accompanying drawing 3, the accompanying drawing 4, the accompanying drawing 5 and the accompanying drawing 6, the present invention provides a labyrinth foldable knife, which comprises a knife handle 6 and a knife body 3 movably connected to the knife handle, wherein a labyrinth groove 9 is formed in the knife handle, a key device 1 being arranged in the labyrinth groove; as shown in FIG. 4, the key device consists of a flange 13, a key 21, a spring 18, a sleeve 29 and a round head screw 31, wherein as shown in FIG. 5, the flange is provided with a hole site 61, which can be buckled in the labyrinth groove to move around, the key is provided with a limiting edge 59, a top of the key is formed into a semicircular body 38 and a bottom thereof is provided with a threaded hole 101 in a recessed manner, an upper end of the round head screw 31 is provided with a threaded section 55 correspondingly connected to the threaded hole to form the accompanying drawing 4, a lower end thereof is formed into a semicircular body 38, the spring 18 is arranged in the sleeve 29 and can stretch up and down, and the key 21 passes through the flange, the spring and the sleeve; and by means of the connection between the threaded hole 101 and the threaded section 55, the key device 1 is buckled in the labyrinth groove 9 and can move back and forth, the semicircular body 38 of the round head screw 31 makes contact with a placing hole site 2 and a push rod 15 arranged at the knife handle during moving of the key device 1, when the key device 1, in the state in the accompanying drawing 3, moves to the position of the push rod 15 in the labyrinth groove 9, the key 21 is pressed to support and jack the push rod to unfold the knife body 3 to the state in the accompanying drawing 2, and when the key device 1 moves to the position of the placing hole site 2, the round head screw 31 is supported and jacked by the spring 18 to enable the semicircular body 38 to be buckled in the placing hole site 2 to lock the key device 1.

Preferably, the labyrinth groove 9 consists of a rapid guide groove 69 and a slow guide groove 8, wherein the groove width of the labyrinth groove 9 is set to 1 mm to 1 cm, and the groove depth thereof is set to 1 mm to 2 cm; and the key device 1 can rapidly unfold the knife body 3 through the movement of the rapid guide groove, and can slowly unfold the knife body 3 through the movement of the slow guide groove 8.

Preferably, due to the fact that there are fewer bends on the rapid guide groove 69 and more bends on the slow guide groove 8, if it is intended to rapidly unfold the knife body 3 for use, the rapid guide groove 69 is selected, and if it is intended to slowly unfold the knife body 3, the slow guide groove 8 is used; and of course, the key device 1 may also be purely used for walking through a labyrinth to exercise a hand to promote the blood circulation, so as to achieve the effect of the multiple functions of the foldable knife and multiple purpose integration.

Preferably, what mentioned above is only the optimum embodiment of the present invention, and is not used for limiting the present invention, for example, the present invention may also implement the following technical solution: the present invention provides a labyrinth foldable knife, which comprises a knife handle 6 and a knife body 3 movably connected to the knife handle 6, wherein the knife handle 6 is provided with a labyrinth groove 9, a ball device 11 being arranged in the labyrinth groove 9, and the ball device 11 being arranged in the labyrinth groove and being capable of moving around to make contact with a push rod 15 arranged at the knife handle 6. As shown in the accompanying drawing 6, the same effect can also be realized by adopting this technical solution, and actually, whether to use the key device 1 or the ball device 11 may be determined by a manufacturer in production. What mentioned above is only the preferred embodiment of the present invention and is not used for limiting the present invention. For a person skilled in the art, the present invention may have various amendments and changes, and any modification, equivalent replacement, improvement and the like within the spirit and principle of the present invention should all fall within the scope of protection of the present invention.

What is claimed is:

1. A labyrinth foldable knife, which comprises a knife handle (6) and a knife body (3) movably connected to the knife handle, wherein a labyrinth groove (9) is provided in the knife handle, a key device (1) being arranged in the labyrinth groove; the key device consists of a flange (13), a key (21), a spring (18), a sleeve (29) and a round head screw (31), wherein the flange is provided with a hole site (61), which is movably buckled in the labyrinth groove and can move around, the key is provided with a limiting edge (59), a top of the key is formed into a semicircular body (38) and a bottom thereof is provided with a threaded hole (101) in a recessed manner, an upper end of the round head screw is provided with a threaded section (55) correspondingly connected to the threaded hole, a lower end thereof is formed into a semicircular body (38), the spring is arranged in the sleeve and can stretch up and down, and the key passes through the flange, the spring and the sleeve; and by means of the connection between the threaded hole and the threaded section, the key device is buckled in the labyrinth groove and can move back and forth, the semicircular body of the round head screw makes contact with a placing hole site (2) and a push rod (15) arranged at the knife handle during moving of the key device, when the key device moves to the position of the push rod in the labyrinth groove, the key is pressed to support and jack the push rod to unfold the knife body, and when the key device moves to the position of the placing hole site, the round head screw is supported and jacked by the spring to enable the semicircular body to be buckled in the placing hole site to lock the key device.

2. The labyrinth foldable knife according to claim 1, wherein the labyrinth groove consists of a rapid guide groove (69) and a slow guide groove (8), the groove width of the labyrinth groove is set to 1 mm to 1 cm, and the groove depth thereof is set to 1 mm to 2 cm; and the key device can rapidly unfold the knife body through the movement of the rapid guide groove, and can slowly unfold the knife body through the movement of the slow guide groove.
